(19) United States
(12) Patent Application Publication
(10) Pub. No.: US 2007/0082133 A1
(43) Pub. Date: Apr. 12, 2007

(54) Method of metallizing a silicone rubber substrate

(76) Inventors: Fumito Nishida, Midland, MI (US); Timothy Lauer, Freeland, MI (US); Udo Pernisz, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 10/573,623

(22) PCT Filed: Aug. 26, 2004
(86) PCT No.: PCT/US04/27744

§ 371 Date: Mar. 28, 2006

(30) Foreign Application Priority Data
Nov. 17, 2003 (US) 60520598

(51) Int. Cl. B05D 3/00

(52) U.S. Cl. 427/299

(57) ABSTRACT

A method of metallizing a silicone rubber substrate, the method comprising the steps of (i) depositing a primer layer of aluminum on a surface of a silicone rubber substrate, and (ii) depositing a layer of a ductile metal on the primer layer of aluminum, wherein the ductile metal is selected from gold, platinum, palladium, copper, silver, aluminum, and indium.

### FIELD OF THE INVENTION

The present invention relates to a method of metallizing a silicone rubber substrate and more particularly to a method of metaling a silicone rubber substrate employing a primer layer of aluminum on a surface of the substrate.

### BACKGROUND OF THE INVENTION

Ductile metals such as gold often exhibit poor adhesion to glass or resinous substrates. One approach to improving adhesion involves depositing a primer layer of a metal such as chromium, nickel, platinum, palladium, and titanium on the substrate to a thickness on the order of nanometers prior to depositing gold. Although, such metals may improve the adhesion of gold to hard materials with low thermal expansion such as epoxy, they are often too brittle for use on materials having high thermal expansion, such as silicone rubber. As a result, use of such metals as a primer on silicone rubber often results in crack formation in the gold layer.

Another approach to improving adhesion features roughening the surface of a substrate by etching prior to depositing a metal layer. However, such methods involve complex processing and limit the choice of substrate materials. As a result, these methods can reduce throughput and increase the cost associated with manufacturing metallized articles.

Of the aforementioned approaches, the use of a primer layer, provides a simpler method for improving adhesion. However, unlike conventional methods, which use primers such as chromium, which are too brittle and result in cracking of the metal overlayer, there is a need for a method of improving the adhesion of metals to silicone rubber that reduces cracking.

### SUMMARY OF THE INVENTION

The present invention is directed to a method of metallizing a silicone rubber substrate, the method comprising the steps of (i) depositing a primer layer of aluminum on a surface of a silicone rubber substrate, and (ii) depositing a layer of a ductile metal on the primer layer of aluminum, wherein the ductile metal is selected from gold, platinum, palladium, copper, silver, aluminum, and indium.

The method of the present invention employing a primer layer of aluminum on a silicone rubber substrate produces a metallized silicone rubber article containing a layer of a ductile metal having reduced cracking compared to a similar method employing a conventional primer layer, such as chromium, nickel, platinum, palladium, or titanium. Typically, the layer of ductile metal is free of cracks, as determined by visual inspection with the unaided eye. Also, the method is scaleable to a high throughput manufacturing process. Importantly, the method employs conventional techniques and equipment and readily available silicone compositions.

The method of the present invention can be used to fabricate numerous articles, including electrodes, printed circuits, electro-optic components having reflective surfaces or interfaces, and decorative ornamental articles.

These and other features, aspects, and advantages of the present invention will become better understood with reference to the following description and appended claims.

### DETAILED DESCRIPTION OF THE INVENTION

According to the present invention, a method of metallizing a silicone rubber substrate comprises the steps of (i) depositing a primer layer of aluminum on a surface of a silicone rubber substrate; and (ii)depositing a layer of a ductile metal on the primer layer of aluminum, wherein the ductile metal is selected from gold, platinum, palladium, copper, silver, aluminum, and indium.

In step (i) of the present method, a primer layer of aluminum is deposited on a surface of a silicone rubber substrate. The silicone rubber substrate can comprise any silicone rubber, filled or unfilled, known in the art. Moreover, the silicone rubber substrate can have any desired shape. As used herein, the term “silicone rubber” refers to a product prepared by curing (vulcanizing or cross-linking) an organopolysiloxane polymer. The mechanical and chemical properties of the silicone rubber substrate depend on the type of polymer, nature and amount of other components in the formulation, processing technique, and method of cure. For example, the silicone rubber substrate can have a hardness of from 5 to 90 Shore A and a consistency ranging from a soft gel to a tough elastomer. Also, the silicone rubber substrate typically has a coefficient of linear thermal expansion of at least 2×10⁻⁴° C⁻¹.

The silicone rubber substrate can be prepared by converting a curable silicone composition into a desired shape by conventional methods, such as compression molding, injection molding, extrusion, and calendaring; and then curing the composition. As used herein, the term “curing” means the conversion of a liquid or semisolid composition to a cross-linked product. Examples of curable silicone compositions include, but are not limited to, hydrosilylation-curable silicone compositions, peroxide curable silicone compositions, condensation-curable silicone compositions, epoxy-curable silicone compositions; ultraviolet radiation-curable silicone compositions, and high-energy radiation-curable silicone compositions.

Curable silicone compositions and methods for their preparation are well known in the art. For example, a suitable hydrosilylation-curable silicone composition typically comprises (i) an organopolysiloxane containing an average of at least two silicon-bonded alkenyl groups per molecule, (ii) an organohydrogensiloxane containing an average of at least two silicon-bonded hydrogen atoms per molecule in an amount sufficient to cure the composition, and (iii) a hydrosilylation catalyst. The hydrosilylation catalyst can be any of the well-known hydrosilylation catalysts comprising a platinum group metal, a compound containing a platinum group metal, or a microencapsulated platinum group metal-containing catalyst. Platinum group metals include platinum, rhodium, ruthenium, palladium, osmium and iridium. Preferably, the platinum group metal is platinum, based on its high activity in hydrosilylation reactions.

The hydrosilylation-curable silicone composition can be a one-part composition or a multi-part composition comprising the components in two or more parts. Room-temperature vulcanizable (RTV) compositions typically comprise two parts, one part containing the organopolysiloxane and catalyst and another part containing the organohydrogensiloxane and any optional ingredients. Hydrosilylation-curable silicone compositions that cure at elevated temperatures can be formulated as one-part or multi-part compositions. For example, liquid silicone rubber (LSR) compositions are typically formulated as two-part systems. One-part compositions typically contain a platinum catalyst inhibitor to ensure adequate shelf life.

A suitable peroxide-curable silicone composition typically comprises (i) an organopolysiloxane and (ii) an organic peroxide. Examples of organic peroxides include, diaroyl peroxides such as dibenzoyl peroxide, di-p-chlorobenzoyl peroxide, and bis-2,4-dichlorobenzoyl peroxide; dialkyl peroxides such as di-t-butyl peroxide and 2,5-dimethyl-2,5-di-(t-butylperoxy)hexane; diaralkyl peroxides such as dicumyl peroxide; alkyl aralkyl peroxides such as t-butyl cumyl peroxide and 1,4-bis(t-butylperoxyisopropyl)benzene; and alkyl aroyl peroxides such as t-butyl perbenzoate, t-butyl peracetate, and t-butyl peroctoate.

A condensation-curable silicone composition typically comprises (i) an organopolysiloxane containing an average of at least two hydroxy groups per molecule; and (ii) a tri- or tetra-functional silane containing hydrolysable Si—O or Si—N bonds. Examples of silanes include alkoxysilanes such as CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH₂═CHSi[O—N═C(CH₃)CH₂CH₃]₃; organoacetamidosilanes such as CH₃Si[NHC(═O)CH_{3]}₃ and C₆H₅Si[NHC(═O)CH₃]₃; aminosilanes such as CH₃Si[NH(s-C₄H₉)]₃ and CH₃Si(NHC₆H₁₁)₃; and organoaminooxysilanes.

A suitable condensation-curable silicone composition can also contain a condensation catalyst to initiate and accelerate the condensation reaction. Examples of condensation catalysts include, but are not limited to, amines; and complexes of lead, tin, zinc, and iron with carboxylic acids. Tin(II) octoates, laurates, and oleates, as well as the salts of dibutyl tin, are particularly useful. The condensation-curable silicone composition can be a one-part composition or a multi-part composition comprising the components in two or more parts. For example, room-temperature vulcanizable (RTV) compositions can be formulated as one-part or two-part compositions. In the two-part composition, one of the parts typically includes a small amount of water.

A suitable epoxy-curable silicone composition typically comprises (i) an organopolysiloxane containing an average of at least two epoxy-functional groups per molecule and (ii) a curing agent. Examples of epoxy-functional groups include 2-glycidoxyethyl, 3-glycidoxypropyl, 4-glycidoxybutyl, 2,(3,4-epoxycyclohexyl)ethyl, 3-(3,4-epoxycyclohexyl)propyl, 2,3-epoxypropyl, 3,4-epoxybutyl, and 4,5-epoxypentyl. Examples of curing agents include anhydrides such as phthalic anhydride, hexahydrophthalic anhydride, tetrahydrophthalic anhydride, and dodecenylsuccinic anhydride; polyamines such as diethylenetriamine, triethylenetetramine, diethylenepropylamine, N-(2-hydroxyethyl)diethylenetriamine, N,N′-di(2-hydroxyethyl)diethylenetriamine, m-phenylenediamine, methylenedianilne, aminoethyl piperazine, 4,4-diaminodiphenyl sulfone, benzyldimethylamine, dicyandiamide, and 2-methylimidazole, and triethylamine; Lewis acids such as boron trifluoride monoethylamine; polycarboxylic acids; polymercaptans; polyamides; and amidoamines.

A suitable ultraviolet radiation-curable silicone composition typically comprises (i) an organopolysiloxane containing radiation-sensitive functional groups and (ii) a photoinitiator. Examples of radiation-sensitive functional groups include acryloyl, methacryloyl, mercapto, epoxy, and alkenyl ether groups. The type of photoinitiator depends on the nature of the radiation-sensitive groups in the organopolysiloxane. Examples of photoinitiators include diaryliodonium salts, sulfonium salts, acetophenone, benzophenone, and benzoin and its derivatives.

A suitable high-energy radiation-curable silicone composition comprises an organopolysiloxane polymer. Examples of organpolyosiloxane polymers include polydimethylsiloxanes, poly(methylvinylsiloxanes), and organohydrogenpolysiloxanes. Examples of high-energy radiation include γ-rays and electron beams.

The curable silicone composition of the present invention can comprise additional ingredients, provided the ingredient does not adversely affect adhesion of the primer layer to the silicone rubber or adhesion of the ductile metal to the primer layer. Examples of additional ingredients include, but are not limited to, adhesion promoters, solvents, inorganic fillers, photosensitizers, antioxidants, stabilizers, pigments, and surfactants. Examples of inorganic fillers include, but are not limited to, natural silica such as crystalline silica, ground crystalline silica, and diatomaceous silica; synthetic silicas such as fused silica, silica gel, pyrogenic silica, and precipitated silica; silicates such as mica, wollastonite, feldspar, and nepheline syenite; metal oxides such as aluminum oxide, titanium dioxide, magnesium oxide, ferric oxide, beryllium oxide, chromium oxide, and zinc oxide; metal nitrides such as boron nitride, silicon nitride, and aluminum nitride, metal carbides such as boron carbide, titanium carbide, and silicon carbide; carbon black; graphite; alkaline earth metal carbonates such as calcium carbonate; alkaline earth metal sulfates such as calcium sulfate, magnesium sulfate, and barium sulfate; molybdenum disulfate; zinc sulfate; kaolin; talc; glass fiber; glass beads such as hollow glass microspheres and solid glass microspheres; aluminum trihydrate; asbestos; and metallic powders such as aluminum, copper, nickel, iron, and silver powders.

The silicone composition can be cured by exposure to ambient temperature, elevated temperature, moisture, or radiation, depending on the particular cure mechanism. For example, one-part hydrosilylation-curable silicone compositions are typically cured at an elevated temperature. Two-part hydrosilylation-curable silicone compositions are typically cured at room temperature or an elevated temperature. One-part condensation-curable silicone compositions are typically cured by exposure to atmospheric moisture at room temperature, although cure can be accelerated by application of heat and/or exposure to high humidity. Two-part condensation-curable silicone compositions are typically cured at room temperature; however, cure can be accelerated by application of heat. Peroxide-curable silicone compositions are typically cured at an elevated temperature. Epoxy-curable silicone compositions are typically cured at room temperature or an elevated temperature. Depending on the particular formulation, radiation-curable silicone compositions are typically cured by exposure to radiation, for example, ultraviolet light, gamma rays, or electron beams.

The primer layer of aluminum typically has a thickness of from 1 to 200 nm, alternatively from 1 to 35 nm, alternatively from 1 to 5 nm. When the primer layer is less than 1 nm, the ductile metal may have a poor adhesion to the primer layer and also have cracks and/or wrinkles.

Methods of depositing aluminum are well known in the art. For example, the primer layer of aluminum can be deposited on a surface of the silicone rubber substrate by physical vapor deposition (PVD) methods, including thermal evaporation, DC magnetron sputtering, and RF sputtering.

In step (ii) of the present method, a layer of a ductile metal is deposited on the primer layer of aluminum. The ductile metal is selected from gold, platinum, palladium, copper, silver, aluminum, and indium. The layer of ductile metal typically has thickness of from 20 to 500 nm, alternatively from 50 to 500 nm, alternatively form 150 to 500 nm. The layer of a ductile metal can be deposited by conventional PVD methods, as described above for the primer layer.

The method of the present invention employing a primer layer of aluminum on a silicone rubber substrate produces a metallized silicone rubber article containing a layer of a ductile metal having reduced cracking compared to a similar method employing a conventional primer layer, such as chromium, nickel, platinum, palladium, or titanium. Typically, the layer of ductile metal is free of cracks, as determined by visual inspection with the unaided eye. Also, the method is scaleable to a high throughput manufacturing process. Importantly, the method employs conventional techniques and equipment and readily available silicone compositions.

The method of the present invention can be used to fabricate numerous articles, including electrodes, printed circuits, electro-optic components having reflective surfaces or interfaces, and decorative ornamental articles.

That which is claimed is:

1. A method of metallizing a silicone rubber substrate, the method comprising the steps of:
(i) depositing a primer layer of aluminum on a surface of a silicone rubber substrate, and
(ii) depositing a layer of a ductile metal on the primer layer of aluminum, wherein the ductile metal is selected from: gold, platinum, palladium, copper, silver, aluminum, and indium.

2. The method according to claim 1, wherein the silicone rubber substrate is prepared by curing a curable silicone composition selected from a hydrosilylation-curable silicone composition, a peroxide curable silicone composition, a condensation-curable silicone composition, an epoxy-curable silicone composition; an ultraviolet radiation-curable silicone composition, and a high-energy radiation-curable silicone composition.

3. The method according to claim 2, wherein the curable silicone composition further comprises an inorganic filler.

4. The method according to claims 1, 2, or 3, wherein the primer layer of aluminum has a thickness of from 1 to 200 nm.

5. The method according to claims 1, 2, 3, or 4, wherein the layer of a ductile metal has a thickness of from 20 to 500 nm.

6. The method according to claims 1, 2, 3, 4, or 5, wherein the ductile metal is gold or platinum.
